(19) United States
(12) Patent Application Publication
(10) Pub. No.: US 2019/0241697 A1
(43) Pub. Date: Aug. 8, 2019

(54) CHEMICALLY DECOMPOSABLE THERMOSETTING RESIN COMPOSITION FOR RECYCLING FIBER-REINFORCED COMPOSITE AND DISSOLVING METHOD THEREOF

(71) Applicant: Korea Institute of Machinery & Materials, Daejeon (KR)

(72) Inventors: Jin Woo YI, Changwon-si (KR); Moon-Kwang UM, Changwon-si (KR); Sangwoo KIM, Goyang-si (KR); Kang Eun LEE, Changwon-si (KR); Youngseok OH, Glmhae-si (KR); Dong Gi SEONG, Changwon-si (KR)

(73) Assignee: Korea Institute of Machinery & Materials, Daejeon (KR)

(21) Appl. No.: 16/318,582

(22) PCT Filed: Feb. 23, 2017
(86) PCT No.: PCT/KR2017/001972

§ 371 Date: Jan. 17, 2019

(30) Foreign Application Priority Data
Jul. 27, 2016 (KR) 10-2016-0095271

(51) Int. Cl. C08G 59/42; D01F 9/24; C08J 11/08; C08J 3/24; C08K 3/26; C08L 63/00; C08K 5/06; C08K 7/06

(52) U.S. Cl. CPC C08G 59/42; D01F 9/24; C08J 11/08; C08J 3/24; C08L 2312/00; C08L 63/00; C08K 5/06; C08K 7/06; C08J 2363/00; C08K 3/26

(57) ABSTRACT

Disclosed is a chemically decomposable thermosetting resin composition for recycling a fiber-reinforced composite, including an epoxy resin, a multifunctional glycidyl-ester-based compound, an additive having a hydroxyl group on at least one of terminals of a main chain thereof, and an acid-anhydride-based curing agent, thus exhibiting excellent chemical decomposition performance in a basic solution and a high glass transition temperature. A method of dissolving the thermosetting resin composition is also provided. Thereby, a thermosetting composite material containing a thermosetting resin of the invention enables recycling of carbon fiber through hydrolysis, and thus the carbon fiber recycling industry and the recycled resin industry can be newly expanded. The thermosetting resin can be applied to fields using not only carbon composite materials but also general thermosetting resins, and can be hydrolyzed in a basic solution, which can significantly reduce landfill or disposal costs.

This application is a continuation of PCT International Application No. PCT/KR2017/001972 which has an International filing date of Feb. 23, 2017, and which claims priority to Korean patent application number 1020160095271 filed Jul. 27, 2016, the entire contents of both of which are incorporated herein by reference.

### TECHNICAL FIELD

The present invention relates to a chemically decomposable thermosetting resin composition for recycling a fiber-reinforced composite and a method of dissolving the same.

### BACKGROUND ART

Recently, greenhouse gas emission regulations and fuel economy control systems have been increasingly applied, and as vehicles become more sophisticated, the weight thereof is gradually increasing due to the mounting of various electronic devices and safety kits thereto.

Hence, in order to replace heavy steel, a carbon composite material having light weight and excellent mechanical strength is attracting attention. Furthermore, demand for lightweight carbon composite materials will increase sharply because existing fossil fuel vehicles are required to be lightweight and also because future electric vehicles and fuel cell vehicles have to be increasingly lightweight from the aspects of driving performance and environmental friendliness.

Generally, a carbon fiber composite includes carbon fiber, serving as a reinforcement, and a thermosetting epoxy resin, mainly serving as a matrix responsible for a binder for fiber fixing. A carbon fiber composite is ten times stronger than iron, has a density 1/5 thereof, and is superior in thermal stability at high temperatures, fatigue resistance, heat resistance, corrosion resistance and chemical resistance, and is thus receiving attention as a material for space/aviation, wind energy and national defense.

Meanwhile, a thermosetting resin has superior mechanical properties and good material workability compared to a thermoplastic resin, and is thus mainly applied in industrial places. From glass-fiber-reinforced polyester composite materials used in fields that do not require high mechanical properties to carbon-fiber-reinforced epoxy composite materials that are important in the aerospace industry, approximately 1 million tons of composite materials are produced annually in Europe alone, but recycling of the composite materials using the thermosetting resin is very difficult, and thus an environmental burden cannot be avoided.

For the process of recycling the thermosetting resin, generally, thermosetting composite materials are pulverized into very small particles and used as filler materials for polymers.

In this regard, Masatashi has reported that glass-fiber-reinforced epoxy resin exhibits better physical properties than conventional fillers when added as a filler to epoxy resin, which is useful as paint or an adhesive.

Meanwhile, a chemical recycling process may be exemplified by a method of decomposing a resin into a low-molecular-weight raw material using an acid or an organic solvent. Furthermore, methods of converting composite materials or synthetic resins into fuel using pyrolysis have been studied. However, the process of recycling these waste plastics is still at the development stage or a pilot-scale stage because processing costs are high and the quality of the produced material is very low.

The process of recycling the thermosetting carbon composite material as above is problematic in that carbon fiber cannot be used as it is because it is pulverized, and the pyrolysis process may cause other kinds of environmental pollution.

Therefore, the present inventors have studied the development of chemically decomposable thermosetting resin compositions and thus have ascertained that the thermosetting resin composition according to the present invention may be chemically decomposed in a basic solution and thereby may be recycled, and simultaneously, the fundamental properties of the composite material including the same and the characteristics of the thermosetting resin may be maintained, which culminates in the present invention.

### DISCLOSURE

### Technical Problem

Accordingly, an objective of the present invention is to provide a chemically decomposable thermosetting resin composition.

Another objective of the present invention is to provide a thermosetting composite material, comprising the thermosetting resin composition and a carbon reinforcement, and a method of manufacturing the thermosetting composite material.

Still another objective of the present invention is to provide a method of dissolving the thermosetting resin.

Yet another objective of the present invention is to provide a method of recovering a carbon reinforcement from the thermosetting composite material.

### Technical Solution

In order to accomplish the above objectives, the present invention provides a chemically decomposable thermosetting resin composition, comprising:

an epoxy resin;

a multifunctional glycidyl-ester-based compound;

an additive having a hydroxyl group on at least one of terminals of a main chain thereof; and

an acid-anhydride-based curing agent,

in which the thermosetting resin composition includes, based on 100 wt % of the total amount thereof excluding the curing agent, 1 to 98 wt % of the epoxy resin, 1 to 98 wt % of the multifunctional glycidyl-ester-based compound, and 1 to 30 wt % of the additive having a hydroxyl group on at least one of terminals of the main chain thereof.

In addition, the present invention provides a thermosetting composite material, comprising: the thermosetting resin composition; and

a carbon reinforcement.

In addition, the present invention provides a method of manufacturing the thermosetting composite material, comprising: mixing the thermosetting resin composition with a carbon reinforcement (step 1); and

curing the composition and the carbon reinforcement of step 1 (step 2).

In addition, the present invention provides a method of dissolving a thermosetting resin, comprising: dissolving a thermosetting resin composition from the thermosetting composite material in a basic solution.

In addition, the present invention provides a method of recovering a carbon reinforcement, comprising: dissolving a thermosetting resin from the thermosetting composite material in a basic solution (step a); and

recovering the carbon reinforcement that is not dissolved in the basic solution (step b).

### Advantageous Effects

According to the present invention, a chemically decomposable thermosetting resin composition, comprising an epoxy resin, a multifunctional glycidyl-ester-based compound, an additive having a hydroxyl group on at least one of terminals of a main chain thereof, and an acid-anhydride-based curing agent, can exhibit excellent chemical decomposition performance in a basic solution and has a high glass transition temperature. Thereby, a thermosetting composite material including the thermosetting resin according to the present invention enables recycling of carbon fiber through hydrolysis, and thus the carbon fiber recycling industry and the recycled resin industry can be newly expanded, and the thermosetting resin can be applied to fields using not only carbon composite materials but also general thermosetting resins, and can be hydrolyzed in a basic solution, which can significantly reduce landfill or disposal costs.

### Best Mode

Hereinafter, a detailed description will be given of the present invention.

The present invention pertains to a chemically decomposable thermosetting resin composition, comprising:

an epoxy resin;

a multifunctional glycidyl-ester-based compound;

an additive having a hydroxyl group on at least one of terminals of a main chain thereof; and

an acid-anhydride-based curing agent,

in which the thermosetting resin composition includes, based on 100 wt % of the total amount thereof excluding the curing agent, 1 to 98 wt % of the epoxy resin, 1 to 98 wt % of the multifunctional glycidyl-ester-based compound, and 1 to 30 wt % of the additive having a hydroxyl group on at least one of terminals of the main chain thereof.

Generally, a carbon fiber composite includes carbon fiber, serving as a reinforcement, and a thermosetting epoxy resin, mainly serving as a matrix that plays a role as a binder for fiber fixing. Here, the epoxy resin, which is the thermosetting resin that is mainly used, is a standard bisphenol-A epoxy resin resulting from synthesizing bisphenol A and epichlorohydrin at 60 to 120° C. in the presence of an alkali. The greatest advantage of the above epoxy resin is that reaction shrinkage is very low during the curing process and volatile substances are not generated. Furthermore, it has excellent electrical and mechanical properties, is superior in water resistance and chemical resistance, and has high storage stability and may thus be stored for a long period of time, and thereby is widely industrially used.

The thermosetting resin exhibits superior mechanical properties and good material workability compared to a thermoplastic resin, and is thus mainly applied in industrial places. As for recycling the composite, the conventional process of recycling the thermosetting composite material may include a pulverization process and a pyrolysis process. The pulverization process is problematic in that carbon fiber cannot be used as it is because it is pulverized, and the pyrolysis process may cause secondary environmental pollution.

Therefore, the present invention addresses a thermosetting resin composition, in which carbon fiber of a composite material may be recovered in a form capable of being recycled while minimizing damage to the carbon fiber and also which may be chemically decomposed and is capable of maintaining the fundamental properties of the composite material and the characteristics of the thermosetting resin.

Hereinafter, a detailed description will be given of a chemically decomposable thermosetting resin composition according to the present invention.

In the chemically decomposable thermosetting resin composition according to the present invention,

examples of the epoxy resin may include, but are not particularly limited to, bifunctional epoxy resin, such as diglycidyl ether bisphenol A, diglycidyl ether bisphenol F, diglycidyl ether bisphenol S, diglycidyl ether bisphenol AP, phenoxy, and rubber-modified epoxy, multifunctional epoxy resin, such as phenol novolac, cresol novolac, and glycidyl amine, and derivatives thereof.

As such, the epoxy resin is preferably used in an amount of 1 to 98 wt % based on 100 wt % of the total amount of the thermosetting resin composition excluding the curing agent.

If the amount thereof is less than 1 wt %, the mechanical properties of the thermosetting resin composition may deteriorate. On the other hand, if the amount thereof exceeds 98 wt %, the chemical decomposition performance of the thermosetting resin composition may deteriorate.

In the chemically decomposable thermosetting resin composition according to the present invention,

the multifunctional glycidyl-ester-based compound is not particularly limited, so long as it is a compound containing glycidyl ester, and at least one compound represented by Chemical Formula 1 below may be used.

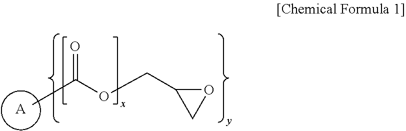

In Chemical Formula 1,

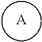

is cycloalkane having 5 to 10 atoms, benzene or naphthalene;

x is 1 to 5; and

y is 1 to 10.

Here, x is preferably 1.

Preferably useful is at least one compound represented by Chemical Formula 5 below.

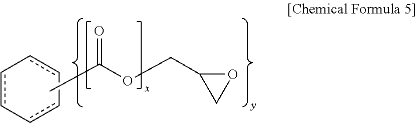

In Chemical Formula 5,

[symbol] is a single bond or a double bond;

x is 1 to 5; and

y is 1 to 6.

Here, x is preferably 1.

More preferably,

used is at least one of:

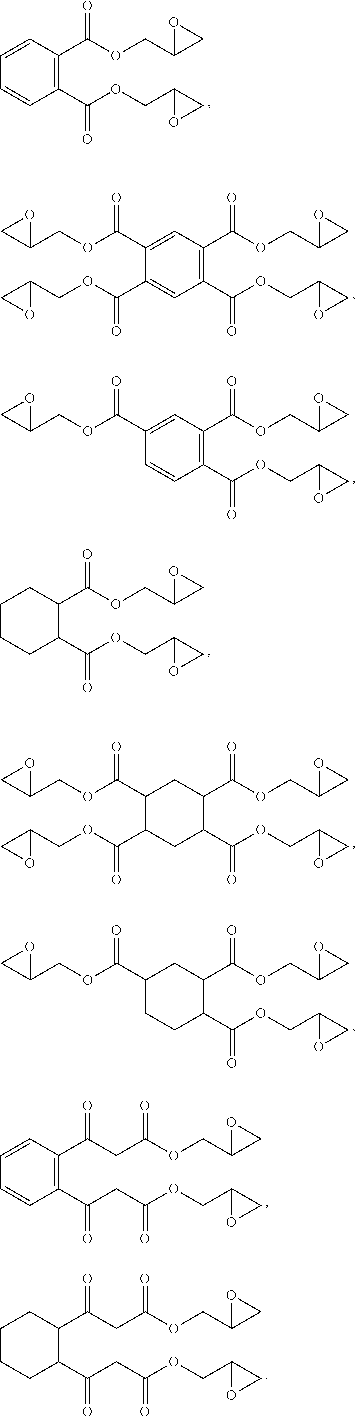

Most preferably,

used is at least one of:

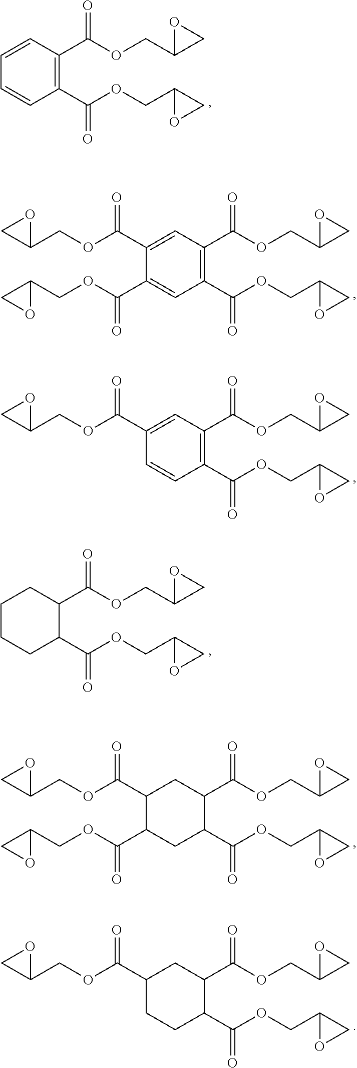

The multifunctional glycidyl-ester-based compound is preferably used in an amount of 1 to 98 wt % based on 100 wt % of the total amount of the thermosetting resin composition excluding the curing agent.

If the amount thereof is less than 1 wt %, the chemical decomposition performance of the thermosetting resin composition may deteriorate. On the other hand, if the amount thereof exceeds 98 wt %, the mechanical properties of the thermosetting resin composition may deteriorate.

Based on the results of evaluation of a resin in a basic solution depending on whether or not the multifunctional glycidyl-ester-based compound is contained, when the glycidyl-ester-based compound is contained, the properties of the thermosetting resin can be confirmed to be maintained by elevating the glass transition temperature (Test Example 1 and Table 2).

In the chemically decomposable thermosetting resin composition according to the present invention,

the additive having a hydroxyl group on at least one of terminals of the main chain thereof may include at least one selected from the group consisting of compounds represented by Chemical Formula 2 to 4 below.

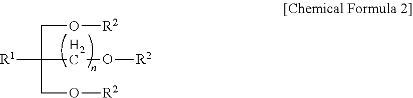

(In Chemical Formula 2,

n is 0 or 1;

R¹ is hydrogen or a linear or branched C₁₋₅ alkyl; and

R²s are each independently

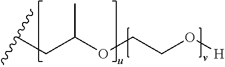

and are the same as or different from each other, wherein u is 0 to 330, v is 0 to 430, both u and v are not zero, and repeating units

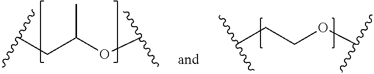

in parentheses are randomly arranged.);

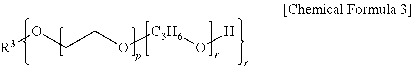

(In Chemical Formula 3,

R³ is hydrogen, a linear or branched C₁₋₅ alkyl, cycloalkane having 5 to 10 atoms, benzene or naphthalene;

r is 1 to 6;

p is 0 to 430, q is 0 to 330, and both p and q are not zero;

repeating units

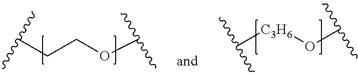

in parentheses are randomly arranged; and

Chemical Formula 3 is configured such that R³ is substituted with

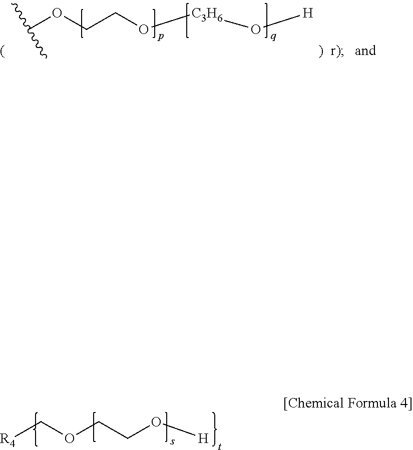

(In Chemical Formula 4,

R⁴ is a linear or branched C₁₋₅ alkyl, cycloalkane having 5 to 10 atoms, benzene or naphthalene;

s is 0 to 430;

t is 1 to 6; and

Chemical Formula 4 is configured such that R⁴ is substituted with

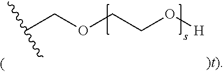

Preferably useful is polyethylene glycol (PEG), polypropylene glycol (PPG); polyethylene glycol methylether; polyethyleneglycol methacrylate; polypropyleneglycol acrylate; a PEG-PPG-PEG triblock copolymer (polyethyleneglycol-polypropyleneglycol-polyethyleneglycol); a PPG-PEG-PPG triblock copolymer (polypropyleneglycol-polyethyleneglycol-polypropyleneglycol); a compound represented by Chemical Formula 2 according to the present invention, in which R¹ is hydrogen, all R²s are the same as each other, and u and v are numerical values such that the total number average molecular weight (Mn) is 150-20,000 g/mol; a compound represented by Chemical Formula 3 according to the present invention, in which R³ is methyl, r is 3, and p and q are numerical values such that the total number average molecular weight (Mn) is 150-20,000 g/mol; a compound represented by Chemical Formula 4 according to the present invention, in which R⁴ is methyl, t is 4, and s is a numerical value such that the total number average molecular weight (Mn) is 150-20,000 g/mol; a compound represented by Chemical Formula 4 according to the present invention, in which R⁴ is ethyl, t is 3, and the total number average molecular weight (Mn) is 150-20,000 g/mol; or the like.

The additive having a hydroxyl group on at least one of terminals of the main chain thereof is preferably used in an amount of 1 to 30 wt % based on 100 wt % of the total amount of the thermosetting resin composition excluding the curing agent.

If the amount thereof is less than 1 wt %, the chemical decomposition performance of the thermosetting resin composition may deteriorate. On the other hand, if the amount thereof exceeds 30 wt %, the glass transition temperature of the thermosetting resin composition may be decreased.

The molecular weight of the additive preferably falls in the range of 150 g/mol to 20000 g/mol. As the molecular weight of the additive decreases, the number of ester groups per unit weight is increased, thus promoting hydrolysis of the resin.

Based on the results of evaluation of a resin in a basic solution depending on the amount of the additive having a hydroxyl group on at least one of terminals of the main chain thereof,

when the additive is not used, decomposition hardly occurs, from which the use of the additive can be confirmed to be essential. When the amount of the additive is 50 wt % or more based on 100 wt % of the total amount of the thermosetting resin composition excluding the curing agent, a weight reduction of 100% may result and thus chemical decomposition performance is very good, but the glass transition temperature is very low, to a level of about 40° C., making it impossible to exhibit the properties of the thermosetting resin. On the other hand, when the amount thereof is less than 50 wt % based on 100 wt % of the total amount of the thermosetting resin composition excluding the curing agent, superior chemical decomposition performance and a high glass transition temperature can be confirmed to be obtained (Test Example 1 and Table 2).

Furthermore, based on the results of evaluation of resin decomposition performance depending on the kind of additive,

when the same kind of additive is used, it can be found that the weight reduction becomes better with a decrease in the number average molecular weight of the additive (Test Example 2 and Table 4).

Therefore, it is essential to use the additive in order to exhibit the chemical decomposition performance of the thermosetting resin according to the present invention, and the amount of the additive that is used is regarded as important in maintaining the properties of the thermosetting resin while exhibiting superior chemical decomposition performance.

In the chemically decomposable thermosetting resin composition according to the present invention,

the acid-anhydride-based curing agent is preferably used in an amount of 70 to 160 parts by weight based on 100 parts by weight of the total amount of the epoxy resin, the multifunctional glycidyl-ester-based compound and the additive having a hydroxyl group on at least one of terminals of the main chain thereof, and is more preferably used in an equivalent weight (when the ratio of the molar sum of the glycidyl functional group contained in the epoxy resin and the glycidyl functional group of the multifunctional glycidyl-ester-based compound to the number of moles of the functional group of the anhydride-based curing agent is 1:1) relative to the epoxy resin and the multifunctional glycidyl-ester-based compound.

If the amount of the acid-anhydride-based curing agent is less than 70 parts by weight based on 100 parts by weight of the total amount of the epoxy resin, the multifunctional glycidyl-ester-based compound and the additive having a hydroxyl group on at least one of terminals of the main chain thereof, the chemical decomposition performance, glass transition temperature and mechanical properties of the thermosetting resin composition may deteriorate. On the other hand, if the amount thereof exceeds 160 parts by weight, the mechanical properties of the thermosetting resin composition may deteriorate.

The acid-anhydride-based curing agent is not particularly limited, but may include phthalic anhydride (PA), succinic anhydride, maleic anhydride, methyl nadic anhydride (MNA), and methyl tetrahydrophthalic anhydride (MeTHPA).

The use of the acid-anhydride-based curing agent facilitates hydrolysis during the resin recycling process through a curing reaction of the acid-anhydride-based curing agent.

The chemically decomposable thermosetting resin composition according to the present invention may further comprise an additional additive, such as a property strengthener, a defoamer, a thickener, a diluent, a heat/oxidation stabilizer, a lubricant, a flame retardant, a heat-resistant additive, or a curing promoter, as well as a filler.

The thermosetting resin composition according to the present invention exhibits a superior weight reduction of 76 to 98%, thus manifesting excellent chemical decomposition performance in a basic solution. Examples 3, 5, 7, 11 and 12 according to the present invention show a weight reduction of 80% or more and a glass transition temperature of 90° C. or higher. In particular, Examples 5, 11 and 12 can be found to be most suitable for a thermosetting resin composition that exhibits a weight reduction of 80% or more and a glass transition temperature of 100° C. or higher and also that is capable of maintaining the fundamental properties of the composite material and the characteristics of the thermosetting resin, as well as showing the chemical decomposition performance desired in the present invention. The preferred component ratio of the epoxy resin to the glycidyl-ester-based compound to the additive in the composition is 20:70:10 by parts by weight (Test Examples 1 and 2 and Tables 2 and 4).

Thus, the chemically decomposable thermosetting resin composition according to the present invention, comprising the epoxy resin, the multifunctional glycidyl-ester-based compound, the additive having a hydroxyl group on at least one of terminals of the main chain thereof, and the acid-anhydride-based curing agent, may exhibit excellent chemical decomposition performance in a basic solution and may have a high glass transition temperature. Thereby, a thermosetting composite material including the thermosetting resin according to the present invention enables recycling of carbon fiber through hydrolysis, and thus the carbon fiber recycling industry and the recycled resin industry may be newly expanded, and the thermosetting resin may be applied to fields using not only carbon composite materials but also general thermosetting resins, and may be hydrolyzed in a basic solution, which may significantly reduce landfill or disposal costs.

In addition, the present invention pertains to a thermosetting composite material, comprising the aforementioned thermosetting resin composition and a carbon reinforcement.

The thermosetting composite material according to the present invention, comprising the aforementioned thermosetting resin composition and the carbon fiber, may be chemically recycled through solvolysis and hydrolysis.

Here, the thermosetting composite material may be dissolved in a basic aqueous solution or a mixed solution of the basic aqueous solution and a salt, and may be dissolved in a solution at 50 to 120° C.

The salt is not particularly limited, but may include potassium chloride (KCl), sodium chloride (NaCl), sodium bromide (NaBr), potassium bromide (KBr), sodium sulfate (Na₂SO₄), magnesium chloride (MgCl₂), sodium thiocyanate (NaSCN), and hydrates thereof.

When the basic aqueous solution including the salt is used, the resin decomposition may be further progressed by virtue of the salt, and thus the weight of the thermosetting resin may be further reduced.

The thermosetting resin of the composite material may be decomposed at 76 wt % or more in the basic solution, and may have a high glass transition temperature, and thus the composite material may be efficiently recycled and the properties of the carbon reinforcement and the thermosetting resin of the composite material may be effectively maintained.

In addition, the present invention pertains to a method of manufacturing a thermosetting composite material, comprising mixing a thermosetting resin composition with a carbon reinforcement (step 1); and

curing the composition and the carbon reinforcement of step 1 (step 2).

Below is a description of the method of manufacturing the thermosetting composite material.

In the method of manufacturing the thermosetting composite material,

the thermosetting resin composition of step 1 may be a chemically decomposable thermosetting resin composition according to the present invention, comprising an epoxy resin, a multifunctional glycidyl-ester-based compound, an additive having a hydroxyl group on at least one of terminals of a main chain thereof, and an acid-anhydride-based curing agent, in which the thermosetting resin composition may include, based on 100 wt % of the total amount thereof excluding the curing agent, 1 to 98 wt % of the epoxy resin, 1 to 98 wt % of the multifunctional glycidyl-ester-based compound, and 1 to 30 wt % of the additive having a hydroxyl group on at least one of terminals of the main chain thereof.

Also, the carbon reinforcement is not particularly limited, so long as it is able to improve the properties of the composite material, for example, the mechanical properties thereof, and at least one selected from among carbon materials, such as carbon fiber, carbon nanotubes, carbon black, graphene, and graphite may be used.

In the method of manufacturing the thermosetting composite material,

the curing of step 2 may be performed through thermal curing because the mixture of step 1 contains the thermosetting resin composition. The curing conditions may vary somewhat depending on the kind of resin. For example, curing may be performed through heating at 80 to 200° C., but the present invention is not limited thereto. The curing process may be typically carried out under thermal curing conditions.

In addition, the present invention pertains to a method of dissolving a thermosetting resin, comprising dissolving a thermosetting resin composition from the thermosetting composite material in a basic solution.

By the method of dissolving the thermosetting resin according to the present invention, the thermosetting composite material may be decomposed. Specifically, the thermosetting resin from the thermosetting composite material may be dissolved using the basic solution, whereby the thermosetting composite material may be decomposed into a thermosetting resin and a carbon fiber.

With reference to conventional techniques, methods of recovering the thermosetting resin from the composite material may include pyrolysis or chemical treatment using a strong base, a strong acid, an organic solvent, etc., but are problematic because environmental pollution occurs and mass treatment becomes impossible. In contrast, the method of dissolving the thermosetting resin according to the present invention enables the thermosetting resin from the thermosetting composite material to be dissolved in a weak basic solution, unlike the conventional techniques, and thus environmental pollution problems may decrease and the treatment process is simple, thus enabling mass treatment.

When the thermosetting composite material is decomposed using the method of dissolving the thermosetting resin according to the present invention, carbon fiber may be recovered and recycled, and moreover, the dissolved thermosetting resin may be recovered and may be added in small amounts in the preparation of other thermosetting resins.

Here, the basic solution is not particularly limited so long as it is a solution that shows basicity, and a basic solution containing an alkali metal such as lithium (Li), sodium (Na), or potassium (K) may be used, and preferably useful is lithium hydroxide (Li0H), sodium hydroxide (NaOH) or potassium hydroxide (KOH).

The basic solution may further contain a salt including an element such as lithium (Li), sodium (Na), potassium (K), rubidium (Rb), cesium (Cs), magnesium (Mg), calcium (Ca), strontium (Sr), or barium (Ba).

When the basic solution further contains the above salt including the alkali element, the extent of dissolution of the thermosetting resin may be further increased.

The temperature of the basic solution may fall in the range of 50 to 120° C., and the thermosetting resin may be efficiently dissolved in the basic solution in the above temperature range.

In addition, the present invention pertains to a method of recovering a carbon reinforcement, comprising dissolving a thermosetting resin from the thermosetting composite material in a basic solution (step a); and

recovering the carbon reinforcement that is not dissolved in the basic solution (step b).

As described above, the composite material, particularly the composite material added with a reinforcement such as carbon fiber, may be increasingly used in a variety of industrial fields. As the amount of the composite material that is used increases, the recycling thereof is also required.

According to the present invention, the method of recovering the carbon reinforcement is used to recover the carbon reinforcement in particular.

Hereinafter, the method of recovering the carbon reinforcement is described below.

In the method of recovering the carbon reinforcement according to the present invention,

step a is dissolving the thermosetting resin from the composite material, particularly the cured composite material, in the basic solution. The basic solution is not particularly limited, so long as it is a solution that shows basicity, and a basic solution including an alkali metal such as lithium (Li), sodium (Na) or potassium (K) may be used, and lithium hydroxide (Li0H), sodium hydroxide (NaOH) or potassium hydroxide (KOH) is preferably used.

The basic solution may further contain a salt including an element such as lithium (Li), sodium (Na), potassium (K), rubidium (Rb), cesium (Cs), magnesium (Mg), calcium (Ca), strontium (Sr), or barium (Ba).

When the basic solution further contains the above salt including the alkali element, the extent of dissolution of the thermosetting resin may be further increased.

The temperature of the basic solution may fall in the range of 50 to 120° C., and the thermosetting resin may be efficiently dissolved in the basic solution in the above temperature range.

In the method of recovering the carbon reinforcement according to the present invention,

step b is recovering the carbon reinforcement that is not dissolved in the basic solution, and when the thermosetting resin of the composite material is dissolved in the basic solution in step a, the carbon reinforcement, which is not dissolved, remains, and the remaining carbon reinforcement may be easily recovered in step b.

The recovered carbon reinforcement may be recycled after a subsequent process such as washing, because it is recovered in its original state.

A better understanding of the present invention will be given through the following examples.

These examples are merely set forth to illustrate the present invention but are not to be construed as limiting the scope of the present invention.

### Mode for Invention

### EXAMPLE 1 TO 13 AND COMPARATIVE EXAMPLE 1 TO 11

### Preparation of Thermosetting Resin Composition

In order to prepare a thermosetting resin composition according to the present invention, respective thermosetting resin compositions of Examples 1 to 13 and Comparative Examples 1 to 11 were synthesized using the components in the amounts shown in Table 1 below. The process of preparing the resin composition was as follows.

<Preparation Process>

An additive and a curing agent were placed in a beaker in the amounts shown in Table 1 below, completely dissolved and mixed with stirring for 30 min at 50° C., after which an epoxy resin was added in the amount shown in Table 1 below and mixed with stirring at 50° C. for 10 min.

The mixed resin was degassed in a vacuum oven at 60° C. for 1 hr, placed in a flat mold, and cured in a two-step mode at 80° C. for 2 hr and 120° C. for 1 hr. The cured resin plate was subjected to mechanical processing into a test specimen having a size of 20 mm×20 mm×3 mm.

TABLE 1

| | | | Glycidyl-ester-based compound of | | | | | Cyclohexene | | | Curing |
|---|---|---|---|---|---|---|---|---|---|---|---|
| | Epoxy resin | | Chemical Formula 1 | | | | | epoxide | | Additive | Agent |
| | YD128 | GEMA | CHEDIG | CHETRIG | CHETRAG | AEDIG | AETRAG | EPOCHE1DIG | CY179 | PEG400 | KBH1089 |
| Example 1 | 35 | — | — | — | — | — | — | — | — | 30 | 97 |
| Example 2 | 35 | — | — | 35 | — | — | — | — | — | 30 | 101 |
| Example 3 | 35 | — | — | — | — | — | — | — | — | 30 | 104 |
| Example 4 | 35 | — | — | — | — | 35 | — | — | — | 30 | 98 |
| Example 5 | 35 | — | — | — | — | — | 35 | — | — | 30 | 105 |
| Example 6 | — | 35 | 35 | — | — | — | — | — | — | 30 | 105 |
| Example 7 | — | 35 | — | — | — | 35 | — | — | — | 30 | 106 |
| Example 8 | 10 | — | 60 | — | — | — | — | — | — | 30 | 104 |
| Example 9 | 10 | — | — | — | — | 60 | — | — | — | 30 | 106 |
| Example 10 | — | 10 | 60 | — | — | — | — | — | — | 30 | 106 |
| Example 11 | 20 | — | 70 | — | — | — | — | — | — | 10 | 108 |
| Example 12 | 20 | — | — | — | — | 70 | — | — | — | 10 | 110 |
| Example 13 | — | 20 | 70 | — | — | — | — | — | — | 10 | 112 |
| Comparative | 100 | — | — | — | — | — | — | — | — | — | 89 |
| Example 1 | | | | | | | | | | | |
| Comparative | — | 100 | — | — | — | — | — | — | — | — | 111 |
| Example 2 | | | | | | | | | | | |
| Comparative | 50 | — | 50 | — | — | — | — | — | — | — | 103 |
| Example 3 | | | | | | | | | | | |
| Comparative | — | 50 | 50 | — | — | — | — | — | — | — | 114 |
| Example 4 | | | | | | | | | | | |
| Comparative | 35 | — | — | — | — | — | — | 35 | — | 30 | 95 |
| Example 5 | | | | | | | | | | | |
| Comparative | 35 | — | — | — | — | — | — | — | 35 | 30 | 102 |
| Example 6 | | | | | | | | | | | |
| Comparative | 50 | — | — | — | — | — | — | — | — | 50 | 86 |
| Example 7 | | | | | | | | | | | |
| Comparative | 70 | — | — | — | — | — | — | — | — | 30 | 87 |
| Example 8 | | | | | | | | | | | |
| Comparative | 25 | — | 25 | — | — | — | — | — | — | 50 | 93 |
| Example 9 | | | | | | | | | | | |
| Comparative | 25 | — | — | — | — | 25 | — | — | — | 50 | 94 |
| Example 10 | | | | | | | | | | | |
| Comparative | — | 25 | 25 | — | — | — | — | — | — | 50 | 99 |
| Example 11 | | | | | | | | | | | |

YD128 (trade name): Diglycidyl ether bisphenol A (standard bisphenol-A epoxy resin)
GEMA (trade name): Tetrafunctional epoxy resin
PEG 400: Polyethylene glycol having molecular weight of 400
KBH1089 (trade name): Methyl nadic anhydride
CHEDIG: 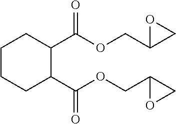 [SMILES: O=C(OCC1CO1)C1CCCCC1C(=O)OCC1CO1] CHETRIG: 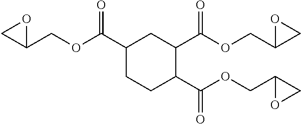 [SMILES: O=C(OCC1CO1)C1CCC(C(=O)OCC2CO2)C(C(=O)OCC2CO2)C1] CHETRAG: 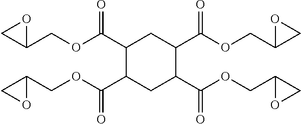 [SMILES: O=C(OCC1CO1)C1CC(C(=O)OCC2CO2)C(C(=O)OCC2CO2)CC1C(=O)OCC1CO1] AEDIG: 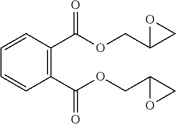 [SMILES: O=C(OCC1CO1)c1ccccc1C(=O)OCC1CO1] AETRAG: 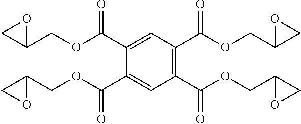 [SMILES: O=C(OCC1CO1)c1cc(C(=O)OCC2CO2)c(C(=O)OCC2CO2)cc1C(=O)OCC1CO1] EPOCHE1DIG: 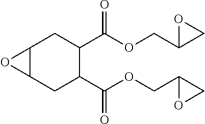 [SMILES: O=C(OCC1CO1)C1CC2OC2CC1C(=O)OCC1CO1] CY179:

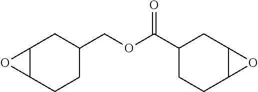 [SMILES: O=C(OCC1CCC2OC2C1)C1CCC2OC2C1]

### TEST EXAMPLE 1

### Resin Decomposition Test 1

In order to evaluate the chemical decomposition performance of the thermosetting resin compositions prepared in Examples 1 to 13 according to the present invention and Comparative Examples 1 to 11, a resin decomposition test was performed. The results are shown in Table 2 below.

Specifically, the thermosetting resin composition of each of Examples 1 to 13 and Comparative Examples 1 to 11 was dissolved in a 0.1 M NaOH aqueous solution at 100° C. for 3 hr, and a resin decomposition test was carried out.

TABLE 2

| | Weight reduction | |
|---|---|---|
| | (%, 3 hr, 100° C., 0.1M NaOH) | Tg (° C.) |
| Example 1 | 93 | 68 |
| Example 2 | 88 | 74 |
| Example 3 | 85 | 91 |
| Example 4 | 83 | 76 |
| Example 5 | 86 | 101 |
| Example 6 | 85 | 88 |
| Example 7 | 82 | 95 |
| Example 8 | 98 | 68 |
| Example 9 | 88 | 77 |
| Example 10 | 90 | 87 |
| Example 11 | 82 | 102 |
| Example 12 | 80 | 113 |
| Example 13 | 76 | 115 |
| Comparative Example 1 | 0.1 | 121 |
| Comparative Example 2 | 0.1 | 175 |
| Comparative Example 3 | 0.1 | 119 |
| Comparative Example 4 | 0.1 | 171 |
| Comparative Example 5 | 5.2 | 48 |
| Comparative Example 6 | 39 | 47 |
| Comparative Example 7 | 100 | 41 |
| Comparative Example 8 | 99 | 41 |
| Comparative Example 9 | 100 | 40 |
| Comparative Example 10 | 100 | 41 |
| Comparative Example 11 | 100 | 41 |

Here, Tg (° C.) is the glass transition temperature.

As is apparent from Table 2,

the compounds of Examples 1 to 13 according to the present invention exhibited superior weight reduction of 76 to 98%, and thus the thermosetting resin according to the present invention can be concluded to manifest excellent chemical decomposition performance in a basic solution.

Moreover, when comparing Examples (1 to 5) according to the present invention with Comparative Examples (5 and 6) having the same components in the same amounts, with the exception that cyclohexene epoxide was used in lieu of glycidyl-ester-based compound of the present invention, the thermosetting resin according to the present invention can be found to exhibit significantly superior weight reduction. Thus, in the thermosetting resin composition according to the present invention, the glycidyl-ester-based compound can be concluded to play a role in increasing the chemical decomposition effects of the thermosetting resin.

Furthermore, in order to maintain the thermosetting properties of the thermosetting resin according to the present invention, a high glass transition temperature is essential. In the case where the glycidyl-ester-based compound was not contained, as in Comparative Examples 7 and 8, the weight reduction was 99% or more, and thus excellent chemical decomposition performance resulted, but the glass transition temperature was very low, namely about 40° C., making it impossible to manifest the properties of the thermosetting resin. In contrast, when the glycidyl-ester-based compound was contained, the glass transition temperature was elevated.

In Comparative Examples 3 and 4, in which the additive was not used, there was almost no decomposition. Hence, it is essential to use the additive. As for the amount of the additive that was added, in Comparative Examples 9 to 11, when the amount of the additive was 50 wt % or more based on 100 wt % of the total amount of the thermosetting resin composition excluding the curing agent, a weight reduction of 100% was exhibited and thus chemical decomposition performance was very good, but the glass transition temperature was very low, namely about 40° C., making it impossible to manifest the properties of the thermosetting resin. On the other hand, when the amount of the additive was less than 50 wt % based on 100 wt % of the total amount of the thermosetting resin composition excluding the curing agent, both superior chemical decomposition performance and a high glass transition temperature resulted.

In Examples 3, 5, 7, 11 and 12 according to the present invention, a weight reduction of 80% or more and a high glass transition temperature of 90° C. or higher were shown, thereby maintaining thermosetting properties and simultaneously increasing chemical decomposition performance. In particular, Examples 5, 11 and 12 were most suitable for a thermosetting resin composition that exhibits a weight reduction of 80% or more and a glass transition temperature of 80° C. or higher and also that is capable of maintaining the fundamental properties of the composite material and the characteristics of the thermosetting resin, as well as showing the chemical decomposition performance desired in the present invention.

The chemically decomposable thermosetting resin composition according to the present invention is decomposed in the basic solution, and is thus effective at realizing chemical decomposition performance and simultaneously maintaining the properties of the thermosetting resin. These effects can be confirmed to be due to the use of the glycidyl-ester-based compound and the additive. Furthermore, in order to enhance these effects, the component ratio of the composition is regarded as important. The preferred component ratio of the epoxy resin to the glycidyl-ester-based compound to the additive in the composition can be confirmed to be 20:70:10 by parts by weight.

### EXAMPLES 14 TO 23

### Preparation of Thermosetting Resin Composition

In order to prepare a thermosetting resin composition according to the present invention, the respective thermosetting resin compositions of Examples 14 to 23 were synthesized using the components in the amounts shown in Table 3 below. The process of preparing the resin composition was as follows.

<Preparation Process>

An additive and a curing agent were placed in a beaker in the amounts shown in Table 3 below, completely dissolved and mixed with stirring for 30 min at 50° C., after which an epoxy resin was added in the amount shown in Table 3 below and mixed with stirring at 50° C. for 10 min.

The mixed resin was degassed in a vacuum oven at 60° C. for 1 hr, placed in a flat mold, and cured in a two-step manner at 80° C. for 2 hr and 120° C. for 1 hr. The cured resin plate was subjected to mechanical processing into a test specimen having a size of 20 mm×20 mm×3 mm.

TABLE 3

| | Epoxy | Glycidyl | | | | | | | | | | Curing |
|---|---|---|---|---|---|---|---|---|---|---|---|---|
| | resin | ester | Additive | | | | | | | | | Agent |
| Example | YD128 | CHEDIG | PEG400 | 4ARMPEG20K | 4ARMPEG0.5K | 3ARMEP4K | 3ARMEP0.3K | GCE1K | GCEP4K | 3ARMPEGP0.17K | 3ARMPEGP1K | KBH1089 |
| 1 | 35 | 35 | 30 | — | — | — | — | — | — | — | — | 97 |
| 14 | ″ | ″ | — | 30 | — | — | — | — | — | — | — | 73 |
| 15 | ″ | ″ | — | — | 30 | — | — | — | — | — | — | 112 |
| 16 | ″ | ″ | — | — | — | 30 | — | — | — | — | — | 76 |
| 17 | ″ | ″ | — | — | — | — | 30 | — | — | — | — | 122 |
| 18 | ″ | ″ | — | — | — | — | — | 30 | — | — | — | 87 |
| 19 | ″ | ″ | — | — | — | — | — | — | 30 | — | — | 76 |
| 20 | ″ | ″ | — | — | — | — | — | — | — | 30 | — | 160 |
| 21 | ″ | ″ | — | — | — | — | — | — | — | — | 30 | 87 |
| 11 | 20 | 70 | 10 | — | — | — | — | — | — | — | — | 108 |
| 22 | ″ | ″ | — | — | — | — | — | — | — | 10 | — | 129 |
| 23 | ″ | ″ | — | — | — | — | — | — | — | — | 10 | 105 |

YD128 (trade name): Diglycidyl ether bisphenol A (standard bisphenol-A epoxy resin)
CHEDIG: 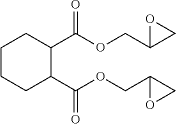 [SMILES: O=C(OCC1CO1)C1CCCCC1C(=O)OCC1CO1] KBH1089 (trade name): Methyl nadic anhydride
PEG 400: Polyethylene glycol having molecular weight of 400
ARMPEG20K: The compound represented by Chemical Formula 4 according to the present invention, in which R⁴ is methyl, t is 4, and s is a numerical value such that the total number average molecular weight (Mn) is 20,000 g/mol.
4ARMPEG0.5K: The compound represented by Chemical Formula 4 according to the present invention, in which R⁴ is methyl, t is 4, and s is a numerical value such that the total number average molecular weight (Mn) is 500 g/mol.
3ARMEP4K: The compound represented by ChemicalFormula 3 according to the present invention, in which R³ is methyl, r is 3, and p and q are numerical values such that the total number average molecular weight (Mn) is 4000 g/mol.
3ARMEP0.3K: The compound represented by Chemical Formula 3 according to the present invention, in which R³ is methyl, r is 3, and p and q are numerical values such that the total number average molecular weight (Mn) is 300 g/mol.
GCE1K: The compound represented by Chemical Formula 2 according to the present invention, in which R⁴ is hydrogen, all R²s are the same as each other, x is 0, and y is a numerical value such that the total number average molecular weight (Mn) is 1000 g/mol.
GCEP4K: The compound represented by Chemical Formula 2 according to the present invention, in which R⁴ is hydrogen, all R²s are the same as each other, and x and y are numerical values such that the total number average molecular weight (Mn) is 4000 g/mol.
3ARMPEGP0.17K: The compound represented by Chemical Formula 4 according to the present invention, in which R⁴ is ethyl, t is 3, and the total number average molecular weight (Mn) is 170 g/mol.
3ARMPEGP1K: The compound represented by Chemical Formula 4 according to the present invention, in which R⁴ is ethyl, t is 3, and the total number average molecular weight (Mn) is 1000 g/mol.

### TEST EXAMPLE 2

### Resin Decomposition Test 2

In order to evaluate the decomposition performance of the thermosetting resin composition according to the present invention depending on the kind of additive, a resin decomposition test was performed. The results are shown in Table 4 below.

Specifically, the thermosetting resin composition of each of Examples 14 to 23 was dissolved in a 0.1 M NaOH aqueous solution at 100° C. for 3 hr, and a resin decomposition test was carried out.

TABLE 4

| | Weight reduction | |
|---|---|---|
| | (%, 3 hr, 100° C., 0.1M NaOH) | Tg (° C.) |
| Example 1 | 93 | 68 |
| Example 14 | 65 | 81 |
| Example 15 | 90 | 79 |
| Example 16 | 69 | 77 |
| Example 17 | 78 | 72 |
| Example 18 | 51 | 88 |
| Example 19 | 53 | 72 |
| Example 20 | 91 | 85 |
| Example 21 | 71 | 89 |
| Example 11 | 82 | 102 |
| Example 22 | 82 | 111 |
| Example 23 | 70 | 116 |

Here, Tg (° C.) is the glass transition temperature.

As is apparent from Table 4,

when the same kind of additive was used, the weight reduction became superior with a decrease in the number average molecular weight of the additive.

When the compounds represented by Chemical Formulas 2, 3 and 4 according to the present invention were used as the additive, the glass transition temperature was higher than when using PEG 400.

Example 22, using, as the additive, the compound (3ARMPEGP0.17K) wherein R⁴ is ethyl, t is 3, and the total number average molecular weight (Mn) is 170, was very superior in both weight reduction (82%) and glass transition temperature (111° C.)

Therefore, the chemically decomposable thermosetting resin composition according to the present invention, comprising the epoxy resin, the multifunctional glycidyl-ester-based compound, the additive having a hydroxyl group on at least one of terminals of the main chain thereof, and the acid-anhydride-based curing agent, has not only excellent chemical decomposition performance in a basic solution but also a high glass transition temperature. Thereby, a thermosetting composite material including the thermosetting resin according to the present invention enables recycling of carbon fiber through hydrolysis, and thus the carbon fiber recycling industry and the recycled resin industry can be newly expanded, and the thermosetting resin can be applied to fields using not only carbon composite materials but also general thermosetting resins, and can be hydrolyzed in a basic solution, which can significantly reduce landfill or disposal costs.

### INDUSTRIAL APPLICABILITY

A thermosetting composite material including a thermosetting resin according to the present invention enables recycling of carbon fiber through hydrolysis, and thus the carbon fiber recycling industry and the recycled resin industry can be newly expanded, and the thermosetting resin can be applied to fields using not only carbon composite materials but also general thermosetting resins.

1. A chemically decomposable thermosetting resin composition, comprising:
an epoxy resin;
a multifunctional glycidyl-ester-based compound;
an additive having a hydroxyl group on at least one of terminals of a main chain thereof, the additive being at least one selected from the group consisting of compounds represented by Chemical Formulas 2 to 4 below; and
an acid-anhydride-based curing agent,
wherein the thermosetting resin composition comprises, based on 100 wt % of a total amount thereof excluding the curing agent, 1 to 98 wt % of the epoxy resin, 1 to 98 wt % of the multifunctional glycidyl-ester-based compound, and 1 to 30 wt % of the additive having a hydroxyl group on at least one of terminals of the main chain thereof: 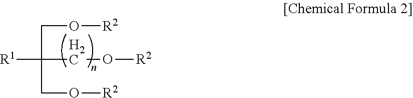
(in Chemical Formula 2,
n is 0 or 1;
R¹ is hydrogen or a linear or branched C₁₋₅ alkyl; and
R²s are each independently 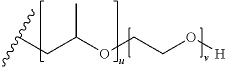
and the same as or different from each other, wherein u is 0 to 330, v is 0 to 430, both u and v are not zero, and repeating units 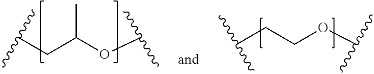
in parentheses are randomly arranged); 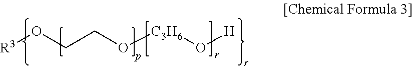
(in Chemical Formula 3,
R³ is hydrogen, a linear or branched C₁₋₅ alkyl, cycloalkane having 5 to 10 atoms, benzene or naphthalene;
r is 1 to 6;
p is 0 to 430, q is 0 to 330, and both p and q are not zero;
repeating units 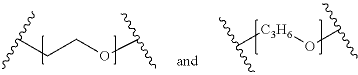
in parentheses are randomly arranged; and
Chemical Formula 3 is configured such that R³ is substituted with 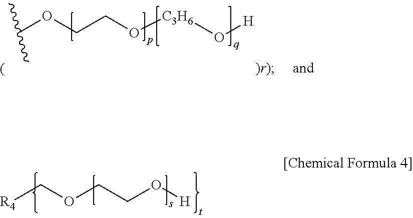
(in Chemical Formula 4,
R⁴ is a linear or branched C₁₋₅ alkyl, cycloalkane having 5 to 10 atoms, benzene or naphthalene;
s is 0 to 430;
t is 1 to 6; and
Chemical Formula 4 is configured such that R⁴ is substituted with

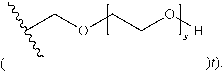

2. The chemically decomposable thermosetting resin composition of claim 1, wherein the multifunctional glycidyl-ester-based compound is at least one compound represented by Chemical Formula 1 below: 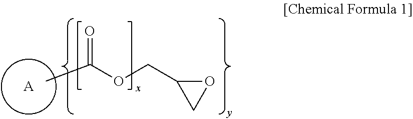
(in Chemical Formula 1, 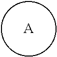
is cycloalkane having 5 to 10 atoms, benzene or naphthalene;
x is 1 to 5; and
y is 1 to 10).

3. The chemically decomposable thermosetting resin composition of claim 1, wherein the acid-anhydride-based curing agent is contained in an amount of 70 to 160 parts by weight based on 100 parts by weight of a total amount of the epoxy resin, the multifunctional glycidyl-ester-based compound and the additive having a hydroxyl group on at least one of terminals of the main chain thereof.

4. The chemically decomposable thermosetting resin composition of claim 1, wherein the acid-anhydride-based curing agent is at least one selected from the group consisting of phthalic anhydride (PA), succinic anhydride, maleic anhydride, methyl nadic anhydride (MNA), and methyl tetrahydrophthalic anhydride (MeTHPA).

5. The chemically decomposable thermosetting resin composition of claim 1, wherein the additive having a hydroxyl group on at least one of terminals of the main chain thereof has a number average molecular weight of 150 to 20000 g/mol.

6. A thermosetting composite material, comprising:
the thermosetting resin composition of claim 1; and
a carbon reinforcement.

7. A method of manufacturing the thermosetting composite material of claim 7, comprising:
mixing the thermosetting resin composition with a carbon reinforcement (step 1); and
curing the composition and the carbon reinforcement of step 1 (step 2).

8. A method of dissolving a thermosetting resin, comprising dissolving a thermosetting resin composition from the thermosetting composite material of claim 6 in a basic solution.

9. The method of claim 8, wherein the basic solution further contains a salt including any one element selected from the group consisting of lithium (Li), sodium (Na), potassium (K), rubidium (Rb), cesium (Cs), magnesium (Mg), calcium (Ca), strontium (Sr), and barium (Ba).

10. The method of claim 8, wherein a temperature of the basic solution is 50 to 120° C.

11. A method of recovering a carbon reinforcement, comprising:
dissolving a thermosetting resin from the thermosetting composite material of claim 6 in a basic solution (step a); and
recovering the carbon reinforcement that is not dissolved in the basic solution (step b).
